(19) United States
(12) Patent Application Publication
(10) Pub. No.: US 2013/0234521 A1
(43) Pub. Date: Sep. 12, 2013

(54) METHOD AND DEVICE FOR MULTIFUNCTIONAL POWER CONVERSION EMPLOYING A CHARGING DEVICE AND HAVING REACTIVE POWER CONTROL

(71) Applicants: Ju Kyoung Eom, Seoul (KR); Gi Su Choi, Gyunggi-do (KR); Joung Hwan Bae, Gyunggi-do (KR)

(72) Inventors: Ju Kyoung Eom, Seoul (KR); Gi Su Choi, Gyunggi-do (KR); Joung Hwan Bae, Gyunggi-do (KR)

(73) Assignee: IN-TECH FACTORY AUTOMATION CO., LTD, Gyunggi-do (KR)

(21) Appl. No.: 13/885,484

(22) PCT Filed: Nov. 4, 2011
(86) PCT No.: PCT/KR2011/008391

§ 371 Date: May 15, 2013

(30) Foreign Application Priority Data
Nov. 15, 2010 (KR) 1020100113183
Feb. 22, 2011 (KR) 1020110015603

(51) Int. Cl. H02J 3/18

(52) U.S. Cl. CPC H02J 3/18
USPC 307/66

(57) ABSTRACT

Provided is a multifunctional power-conversion system which controls active power and reactive power by employing distributed power. With respect to the multifunctional power-conversion system according to the present invention, an auxiliary power device, using wind power and/or solar power, is connected to a power system; and a distributed power device, such as a battery, for temporarily storing power is connected thereto while being connected to the auxiliary power device. A power converter connects a high-capacity power supply source, such as a periodic power source or a main power supply source, to the system. Therefore, the electricity consumption status is checked such that the control of active power and reactive power is enabled.

### TECHNICAL FIELD

The present invention relates to a renewable energy source, a distributed power supply capable of temporarily storing power from a power source, and a power conversion system for stabilizing a power system using the same

### BACKGROUND ART

As the mankind uses fossil energy, such as coal and oil, various environment problems have been emerged, and the mankind is faced with depletion of the fossil energy. Scientists are warning that the fossil energy will be depleted within decades.

Therefore, researchers are researching on various renewable energy sources, e.g., wind power energy, solar power/solar thermal power energy, geothermal energy, etc. However, such renewable energies are still unable to completely replace fossil energy due to high costs of equipment therefor and insufficient payability. However, due to significant seasonal fluctuation of power generated by the major national power infrastructures, such as nuclear power generation, hydroelectric power generation, and thermal power generation, it is necessary to always have power reserves.

### DISCLOSURE OF THE INVENTION

### Technical Problem

For efficient utilization of power generated by a main power supply source, which is a power infrastructure, a renewable energy source may be connected to a power system. In this case, a charging device, such as a battery, is required for appropriate power conversion in consideration of status of a consuming load. Here, if the renewable energy source supplies active power only, reactive power is not sufficiently compensated when capacity of the main power supply source is small or capacity of the renewable energy source is greater than that of the main power supply source, and thus the overall power system becomes unstable. Therefore, an apparatus and a system for efficiently managing the power system operated by the power infrastructure or the main power supply source by compensating reactive energy while renewable energy is being supplied to the power system is required.

### Technical Solution

Embodiments of the present invention include a power conversion device capable of controlling reactive power, the power conversion device including an alternative power input unit, which receives alternative power from one or more auxiliary power supply device; a power conversion switching unit, which converts power received via the alternative power input unit to AC power; a charging power supply unit, which is connected to the alternative power input unit and stores power supplied from at least one from between the alternative power input unit and a grid; and a power control unit, which receives information regarding a power factor, demanded active power, and demanded reactive power from the grid connected to a consuming load and controls a voltage and a current output by the power conversion switching unit and a phase difference between the voltage and the current to satisfy the power factor, the demanded active power, and the demanded reactive power received from the grid.

Embodiments of the present invention also includes a power conversion method capable of controlling reactive power, the power conversion method including an operation in which a power control unit receives information regarding a power factor, demanded active power, and demanded reactive power from a grid connected to a consuming load; an operation in which the power control unit applies a voltage command, a current command, and a power factor command for applying a phase difference between a voltage and a current to be generated to a power conversion switching unit, based on the power factor, the demanded active power, and the demanded reactive power; and an operation in which the power conversion switching unit supplies a voltage and a current from at least one power supply device from among one or more auxiliary power supply devices and charging power supply devices, based on the voltage command, the current command, and the power factor command.

### Advantageous Effects

By using a multi-functional power conversion system of the present application, power supply in a power system may be maintained stable by utilizing alternative power supply sources, such as various renewable energy sources. Furthermore, power of a power system may be efficiently utilized by receiving information regarding active powers and reactive powers at a power supplying grid and a consumer load and compensating not only the active power, but also the reactive power. Therefore, fossil energy used for power generation may be reduced.

### BRIEF DESCRIPTION OF THE DRAWINGS

FIG. 1 is a diagram showing an entire system employing a multi-functional power conversion device according to the present invention;

FIG. 2 is a diagram showing a multi-functional power conversion system for single-phase to three-phase conversion according to an embodiment of the present invention;

FIG. 3 is a diagram showing stand-by status of a system for performing power conversion while power is being supplied by an alternative energy supply source according to an embodiment of the present invention;

FIG. 4A is a diagram showing an example of operations of a system for performing power conversion while power is being supplied by a renewable energy supply source according to an embodiment of the present invention;

FIG. 4B is a diagram showing another example of operations of a system for performing power conversion while power is being supplied by a renewable energy supply source according to an embodiment of the present invention;

FIG. 4C is a diagram showing another example of operations of a system for performing power conversion while power is being supplied by a renewable energy supply source according to an embodiment of the present invention;

FIG. 5A is a diagram showing an example of operations of a system for charging a battery and performing power conversion while power is being supplied by a renewable energy supply source according to an embodiment of the present invention;

FIG. 5B is a diagram showing another example of operations of a system for charging a battery and performing power conversion while power is being supplied by a renewable energy supply source according to an embodiment of the present invention;

FIG. 5C is a diagram showing another example of operations of a system for charging a battery and performing power conversion while power is being supplied by a renewable energy supply source according to an embodiment of the present invention;

FIG. 6 is a diagram showing an example of operations of a system for performing power conversion while power is being supplied by a battery according to an embodiment of the present invention;

FIG. 7 is a diagram showing an example of operations of a system for performing power conversion while power is being supplied by a renewable energy source and a battery according to an embodiment of the present invention;

FIG. 8 is a diagram showing an example of operations of a system for performing power conversion for charging surplus power from a grid to a battery, according to an embodiment of the present invention;

FIG. 9A is a diagram showing an example of operations for supplying only reactive power via a power conversion device due to a difference between power factors of a main power supply and a consuming load;

FIG. 9B is a diagram showing an example of controlling reactive power via a power conversion device based on a power factor of a consuming load;

FIG. 9C is a block diagram of a current controller for controlling reactive power based on a power factor of a consuming load according to an embodiment of the present invention;

FIG. 10 is a diagram showing a system for controlling reactive power and an example of operations for converting powers from a renewable energy source and a battery, according to an embodiment of the present invention;

FIG. 11 is a diagram showing an example of operations for converting powers from a renewable energy and a battery when a grid is blocked, according to an embodiment of the present invention;

FIG. 12 is a block diagram of a power conversion device capable of controlling reactive power according to an embodiment of the present invention; and

FIG. 13 is a flowchart showing a method by which a power controller of a power converter receives information regarding a power factor, demanded active power, and demanded reactive power from a grid to which a consuming load is connected and supplies a voltage and a current to stabilize a power system.

### MODE FOR CARRYING OUT THE INVENTION

The present invention will now be described more fully with reference to the accompanying drawings, in which exemplary embodiments of the invention are shown. The invention may, however, be embodied in many different forms and should not be construed as being limited to the embodiments set forth herein.

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

Like reference numerals in the drawings denote like elements.

The present invention will now be described more fully with reference to the accompanying drawings, in which exemplary embodiments of the invention are shown.

The mankind that has been depending on fossil energy, such as coal and oil, for long time now faces with environmental problems and depletion of fossil energy. Nuclear energy is getting the spotlight as the replacement for the fossil energy. However, nuclear energy also as a risk of radiation leakage and a cost of constructing a nuclear power plant is high.

Recently, alternative energies, that is, renewable energies other than the national power infrastructure, such as nuclear power generation, hydroelectric power generation, and thermal power generation, are being developed. By developing such alternative energies or renewable energies, power dependency on the power infrastructures or the main power supply source in one big power system may be distributed to renewable energy sources, thus being helpful to operation of the power system. In other words, if a distributed power supply, such as a large capacity battery or a charging device, is arranged, a power system operator may monitor status of a consuming load via communication, and, when power demand of the consuming load is at the peak, a renewable energy from the distributed power supply may be accessorily utilized. As a result, a power system may be significantly stabilized.

Furthermore, if a power converter is capable of compensating both active power and reactive power of the consuming load, the power system may be further stabilized. Compensation of reactive power is more essential in a case where capacity of a power infrastructure that supplies power to a consuming load is small. In detail, if a power infrastructure includes a small-scale power generator having a small capacity, such as a diesel power generator, when a renewable energy source is connected thereto for auxiliary power supply and only active power is supplied from the renewable energy source, the corresponding power system may become unstable. Not only in the case where a power infrastructure includes a small-scale power generator, as importance of renewable energy is being emphasized, magnitudes of renewable energies produced by consumers are increasing. As a result, renewable energies will become more significant in the overall power generation, and thus stabilization of a power system will become more important.

If such a renewable energy is capable of appropriately distributing active power and reactive power according to power factor of a power system, the power system may be stably operated with sufficient utilization of the renewable energy.

Therefore, the power conversion device and the power control according to the present invention may not only reduces costs by offsetting reserve power of a power infrastructure by simply adding an alternative energy or a renewable energy, but also may stabilize a power system via reactive power compensation.

Throughout this documentation, the term ‘renewable energy’ and the term ‘alternative energy’ will be used for a same meaning.

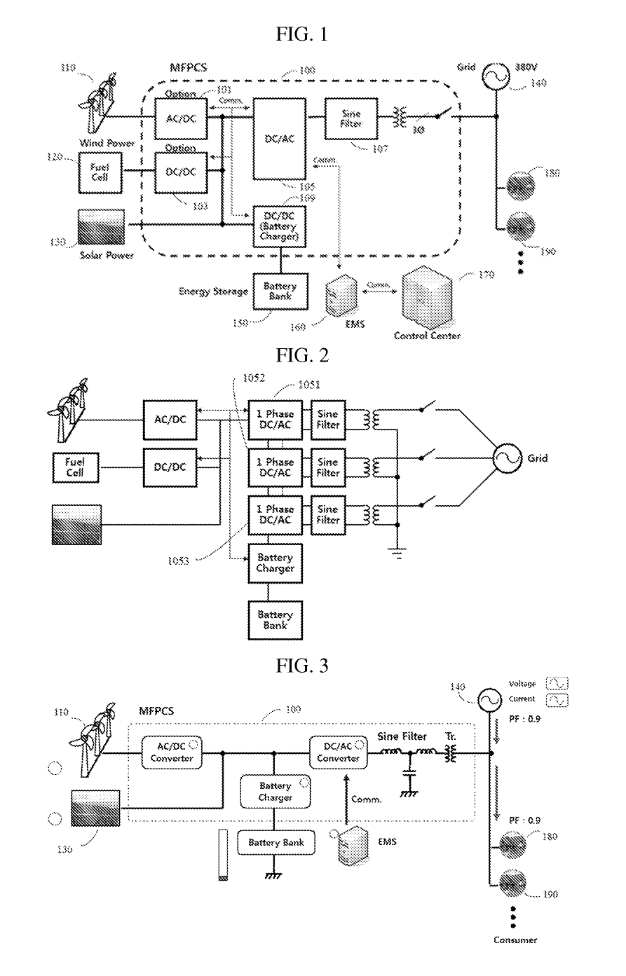

FIG. 1 is a diagram showing an entire system employing a multi-functional power conversion device according to the present invention.

Referring to FIG. 1, various renewable energy sources including a wind power generator 110, a fuel cell 120, and a solar power generator 130 are shown. The alternative energy sources or renewable energy sources shown in FIG. 1 are mere examples, and alternative energy sources and renewable energy sources are not limited thereto. For example, alternative energy sources and renewable energy sources include geothermal power generation, solar thermal power generation, waste power generation, waterpower generation, marine (tidal) power generation, hydrogen power generation, animal/plant/organic material power generation, conventional thermal power generation, etc.

Power dependency of a consuming load on a main power supply 140, such as a main power supply source or a power infrastructure, may be reduced by utilizing such a renewable energy source. To operate such a power system, a multi-functional power conversion system 100 of the present application is included in the power system. The multi-functional power conversion system 100 includes an AC/DC converter 101, which is a converter for converting an alternated current (AC) to a direct current (DC), a DC/DC converter 103, which is a converter for converting a DC to a DC having a different size, a DC/DC battery charger 109, a DC/AC inverter 105, which is an inverter for converting a DC to an AC, and a sine wave rectification filter 107, which includes an inductor for removing harmonic wave noises from a PWM output voltage, such that the PWM output voltage becomes similar to a sine wave.

Furthermore, the multi-functional power conversion system 100 further includes a control center 170 for diagnosing status of a consuming load, receiving information regarding the diagnosis via communication, and transmitting the information to an energy management system (EMS) 160, where the EMS 160 receives the information regarding status of the consuming load from the control center 170 and controls the multi-functional power conversion system 100 based on the information. The EMS 160 may be a power controller and will be used with the same meaning as terms ‘power controller’ and ‘power control unit’ herein. Of course, the EMS 160 and a power controller of the present application may be separate devices. In other words, the EMS 160 may simply receive information regarding a grid and a consumer load, e.g., power factor information, a requesting amount of an active power, and a requesting amount of a reactive power, from the control center 170 and forward the information to a power control unit, so that the power control unit may generate a voltage and a current satisfying the power factor by controlling a switching unit of the multi-functional power conversion system 100 according to the power factor information, the requesting amount of an active power, and the requesting amount of a reactive power. Furthermore, the EMS 160 controls sizes of and a phase difference between an output voltage and an output current by performing d-q conversion required for controlling an inverter (or a converter) and functioning as a related controller, e.g., a PI controller.

Energy generated by a renewable energy source or surplus power from a consuming load or a grid 140 may be charged to a battery bank 150 via the DC/DC battery charger 109. The DC/DC battery charger 109 may also be referred to as a charger or a charging power supply unit.

FIG. 2 is a diagram showing a multi-functional power conversion system for single-phase to three-phase conversion according to an embodiment of the present invention.

The DC/AC inverter 105 shown in FIG. 1 includes three single phase DC/AC 1051, 1052, and 1053 as shown in FIG. 2. Each of the single phases DC/AC 1051, 1052, and 1053 generates one alternated wave, and the three single phases DC/AC 1051, 1052, and 1053 are controlled to be arranged at an interval of 120 degrees. As a result, a three-phase power may be produced.

FIG. 3 is a diagram showing stand-by status of a system for performing power conversion while power is being supplied by an alternative energy supply source according to an embodiment of the present invention.

In FIG. 3, only the grid 140, such as a power infrastructure, is a common power system which supplies power to consuming loads 180 and 190. The multi-functional power conversion system 100 according to an embodiment of the present invention is connected to the grid 140 in the power system, but the multi-functional power conversion system 100 is not operating yet. At this point, it is necessary for the grid 140 to be able to produce power above the peak power to compensate for insufficient active power and reactive power generated by the power system.

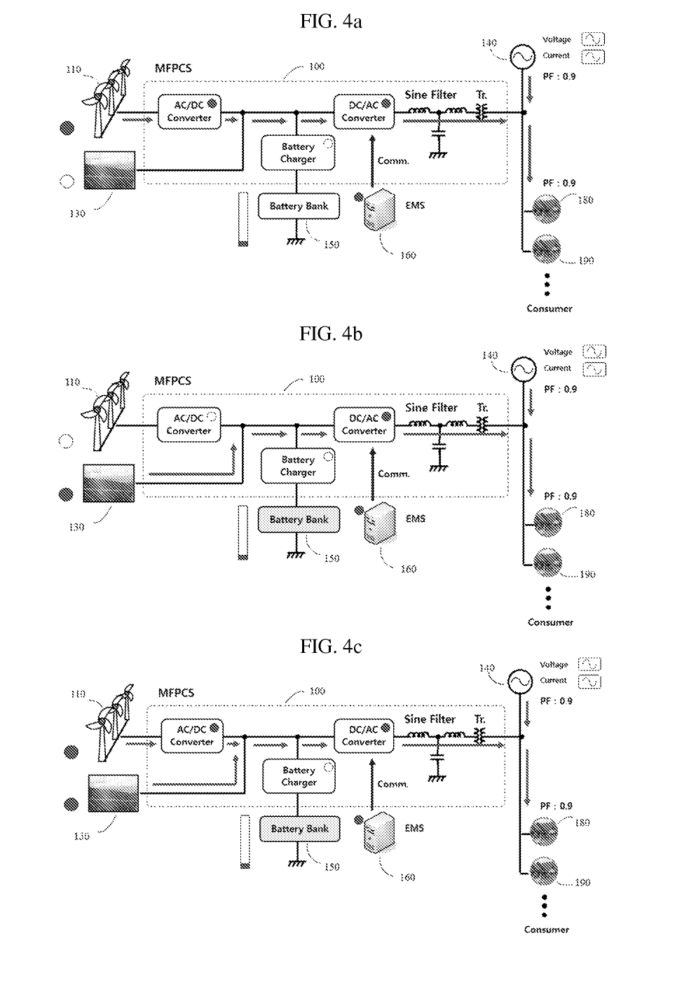

FIG. 4A is a diagram showing an example of operations of a system for performing power conversion while power is being supplied by a renewable energy supply source according to an embodiment of the present invention.

Referring to FIG. 4A, the wind power generator 110 is being operated, and renewable energy generated by the wind power generator 110 is supplied to a power system via the multi-functional power conversion system 100 of the present application. The grid 140 may receive power from the wind power generator 110 via the multi-functional power conversion system 100 to make up shortage of power. FIG. 4A shows a case in which more power than power supplied by the main power supply 140 is required and power may be generated using wind power.

Currently, since power supplied from the main power supply 140 in the entire power system is not sufficient for the consuming loads 180 and 190, it is necessary to supply power from an auxiliary power supply. If solar power generation is difficult for weather conditions and strong wind blows, it is necessary to use alternative power supplied from the wind power generator 110. Therefore, power generated by the wind power generator 110 does not charge an (auxiliary) distributed power supply, such as the battery bank 150, and is directly supplied to the power system. Here, the EMS 160 receives a communication indicating that the power system requires more power, operates the DC/AC inverter 105, and supplies power generated by the wind power generator 110 to the power system.

FIG. 4B shows a case identical to the case shown in FIG. 4A except that the solar power generator 130 functions as an auxiliary power supply for supplying alternative energy instead of the wind power generator 110. In this case, power may be easily generated via solar power generation due to weather conditions. Power generated by the solar power generator 130 is a DC power, and thus no AC/DC conversion is required.

FIG. 4C shows another example of operations of a system for performing power conversion while power is being supplied by a renewable energy supply source according to an embodiment of the present invention. FIG. 4C shows a case in which the wind power generator 110 and the solar power generator 130 operate together.

In any of the cases shown in FIGS. 4A through 4C, generated renewable energy supplements power of a grid. However, while a renewable energy is supplementing power of a grid, if only active power is supplied without considering a ratio between active power and reactive power consumed by a consuming load, the entire power system becomes unstable. If a consuming load always includes resistance components only, it may be preferable for a renewable energy to supply only active power to a power grid. However, there are only a few cases in which consuming loads include resistance components only, and reactive power always exists. Therefore, it is necessary for a voltage and a current supplied from a renewable energy source to supplement power of a grid by reflecting power factor information regarding a consuming load without breaking a power factor relationship. Otherwise, a power system becomes unstable.

The multi-functional power conversion system 100 may control a voltage and a current to have phase differences therebetween by controlling switching of the DC/AC inverter 105 by reflecting power factor information of the consuming loads.

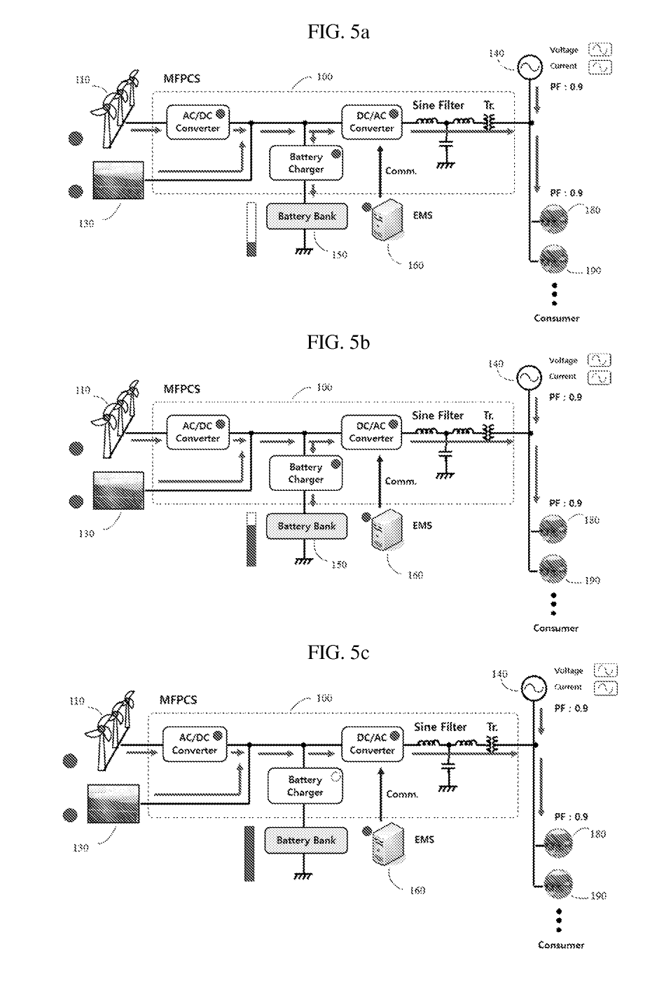

FIG. 5A is a diagram showing an example of operations of a system for charging a battery and performing power conversion while power is being supplied by a renewable energy supply source according to an embodiment of the present invention.

Although powers are being generated by both the wind power generator 110 and the solar power generator 130, if consuming loads in a power system do not require auxiliary power supply, surplus power generated by auxiliary power supply sources are charged to the battery bank 150, which is a distributed power supply and a charging power device. The power charged to the battery bank 150 is temporarily stored and will be useful later when no power is generated by the auxiliary power supply sources or there is an excessive load in the power system.

FIG. 5B is a diagram showing another example of operations of a system for charging a battery and performing power conversion while power is being supplied by a renewable energy supply source according to an embodiment of the present invention. FIG. 5B shows that, since a period of time for performing the operation shown in FIG. 5A is sufficiently long to store sufficient amount of energy in the battery bank 150.

FIG. 5C is a diagram showing another example of operations of a system for charging a battery and performing power conversion while power is being supplied by a renewable energy supply source according to an embodiment of the present invention

The battery bank 150 is completely charged and it is no longer necessary to charge the battery bank 150. Therefore, electric energy generated by the auxiliary power supply sources, that is, the wind power generator 110 and the solar power generator 130 bypasses the distributed power supply, which is the battery bank 150, and is supplied to the consuming loads 180 and 190. If the EMS 160 controls amount of power supplied by the grid 140 by communicating with the grid 140, power efficiency may be significantly improved. The EMS 160, which may be considered as a power controller, may control power supplied from the battery bank 150 and the auxiliary power supply sources to consuming loads. A switch may be arranged at the output end of the battery bank 150 or a connecting end of an auxiliary power supply source and may be controlled by the power controller. Furthermore, power output may also be controlled by switching the DC/AC inverter 105.

Here, if information regarding power factors, demanded active power, and demanded reactive power of the consuming loads 180 and 190 is received, switching control may be performed, such that renewable energies from renewable energy sources, such as the wind power generator 110 and the solar power generator 130, may be supplied to the consuming loads 180 and 190 while active power and reactive power maintain the power factors at the consuming loads 180 and 190. A switching semiconductor therefor may be any of various switching semiconductors commonly used in power conversion devices, e.g., IGBT, GTO, power MOSFET, etc.

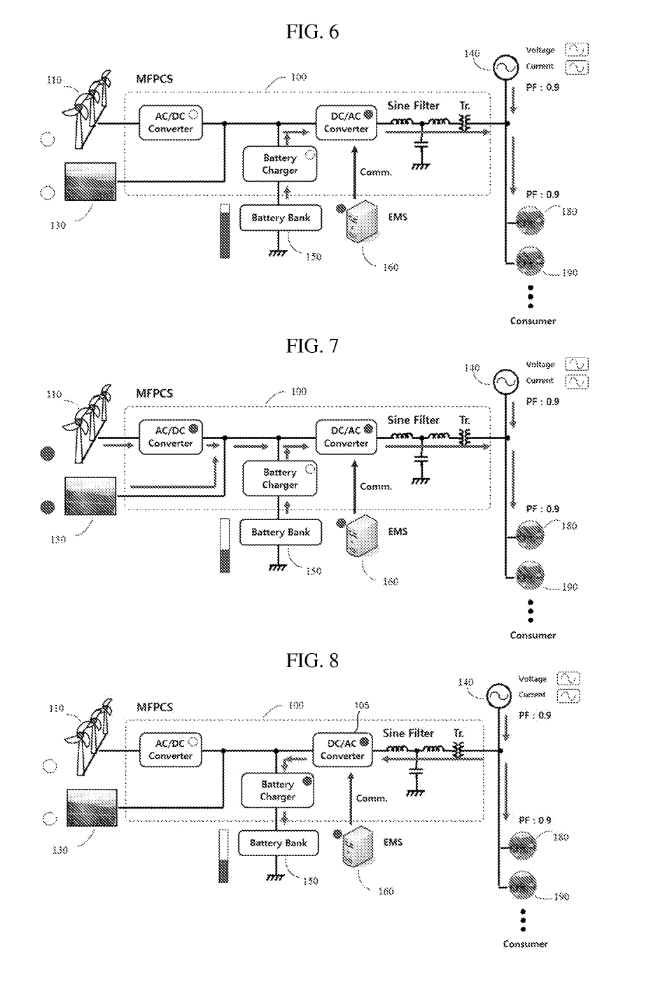

FIG. 6 is a diagram showing an example of operations of a system for performing power conversion while power is being supplied by a battery according to an embodiment of the present invention.

Currently, no power is generated by the auxiliary power supply sources, that is, the wind power generator 110 and the solar power generator 130. However, there are the consuming loads 180 and 190 to which sufficient power cannot be supplied by the grid 140. The EMS 160 receives a communication indicating the power system status and supplies power to the power system by operating the battery bank 150 that is charged in advance. As described above, information regarding power factors, demanded active power, and demanded reactive power of the consuming loads 180 and 190 is received via the EMS 160 in advance and switching control is performed by applying a phase difference to a voltage and a current during DC/AC conversion of power from the battery bank 150, such that demanded power factors, demanded active power, and demanded reactive power are satisfied.

FIG. 7 is a diagram showing an example of operations of a system for performing power conversion while power is being supplied by a renewable energy source and a battery according to an embodiment of the present invention.

Referring to FIG. 7, the power system includes the consuming loads 180 and 190 which demand a large amount of power that may be satisfied only by using powers from all of the wind power generator 110, the solar power generator 130, and the battery bank 150. The EMS 160 frequency receives information regarding status of the consuming loads 180 and 190 and determines whether to continue supplying power from the battery bank 150 to the power system. If it is determined that power generated by the wind power generator 110 and the solar power generator 130 is sufficient for the consuming loads 180 and 190, power supply from the battery bank 150 may be blocked.

FIG. 8 is a diagram showing an example of operations of a system for performing power conversion for charging surplus power from a grid to a battery, according to an embodiment of the present invention.

Currently, an amount of power demanded by the consuming loads 180 and 190 is not very large. Therefore, surplus power is generated by the grid 140, which is a power infrastructure. An example thereof is formation of surplus power at night after supplying a large amount of power during daytime. Here, the EMS 160 checks status of load in a power system. If it is determined that surplus power is being generated, the surplus power may be charged to a distributed power supply, such as the battery bank 150. At this point, the switching device (diode) of the DC/AC inverter 105 functions as a rectifier and may charge AC power from the grid 140 to the battery bank 150.

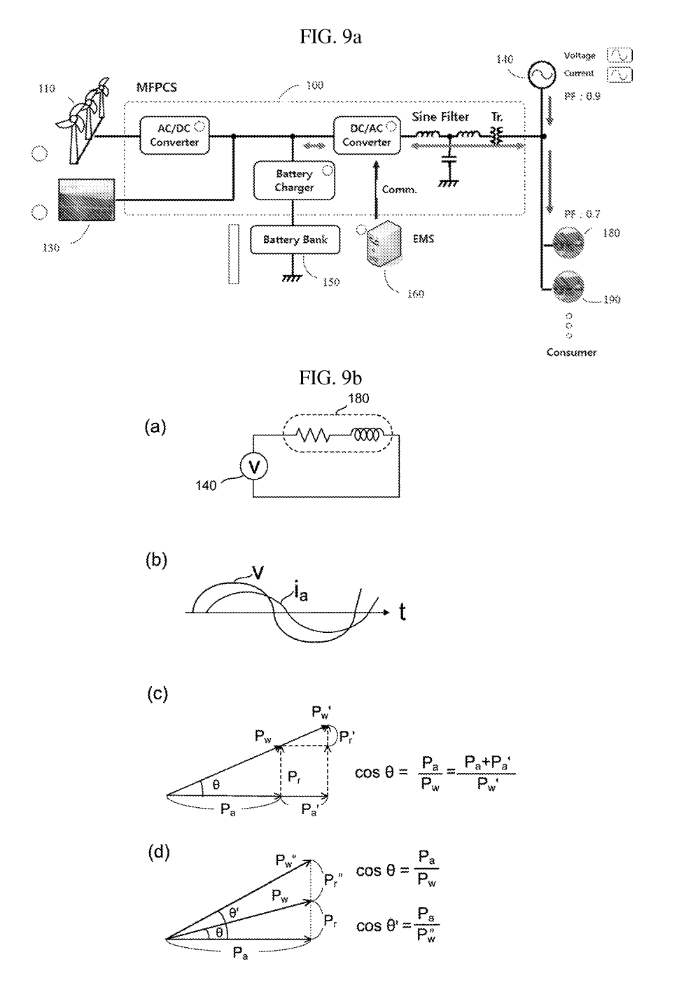

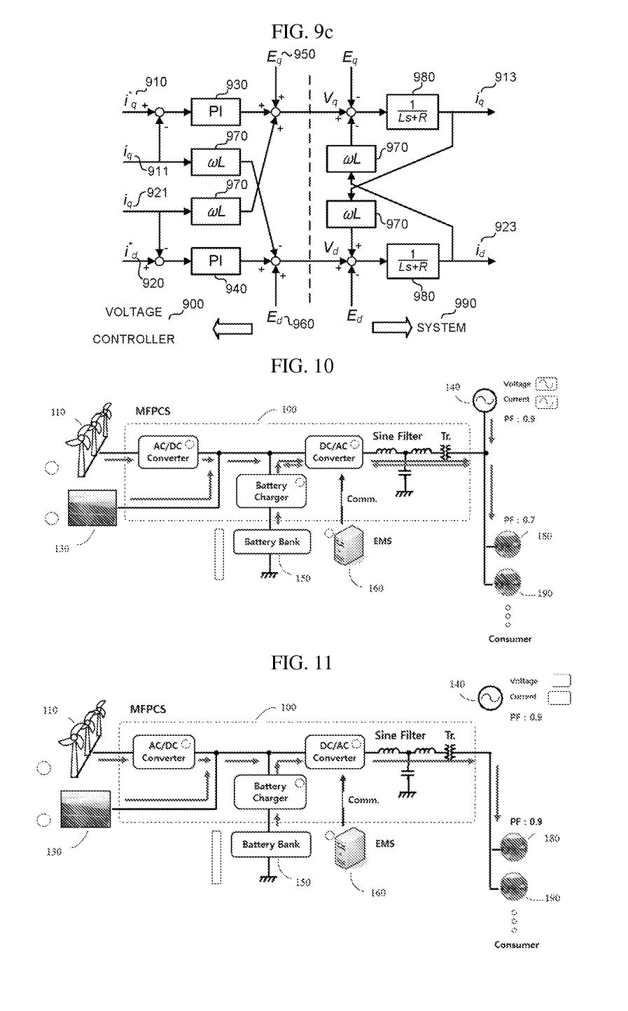

FIG. 9A is a diagram showing an example of operations for supplying only reactive power via a power conversion device due to a difference between power factors of a main power supply and a consuming load.

Currently, the power factor at the consuming loads 180 and 190 is 0.7, whereas the power factor of the main power supply is 0.9. In this case, the multi-functional power conversion system 100 may control reactive power. For example, when electric power stored in the battery bank 150 is converted to AC power via the DC/AC inverter 105, such that a phase difference between an output voltage and an output current is 90 degrees, only reactive power may be supplied, and the power factor (0.7) of the consuming load may be satisfied by controlling supply of the reactive power. In this case, only reactive power is supplied to a grid and the consuming load.

Referring to FIG. 9B, reactive power compensation at a power converter of the present application will be described in detail.

As shown in (a) of FIG. 9B, power from the main power supply 140 (or the grid 140; commonly, a power infrastructure of Korea Electric power corporation) is AC power and the consuming load 180 has an equivalent circuit including a resistor and an inductor as shown in (a), a current is becomes a lagging current having a phase difference with respect to a voltage v. Here, if both active power and reactive power are required in the entire power system, a power converter of the present application may supply the corresponding active power and reactive power.

In detail, referring to (c), if there is reactive power Pr with respect to active power Pa, the overall power is Pw and power factor PF is PF=cos θ=Pa/Pw. Here, it is assumed that the maximum power that may be supplied by the main power supply, which is the grid, is Pw, whereas the entire consuming loads require the overall power Pw′. In this case, in FIG. 9A, the EMS 160 receives information regarding power factor (cos θ) from the grid and calculates sizes of active power and reactive power for compensation (control). Since a power control device is aware of the power factor cos θ, a power conversion device supplies power via a switching unit, that is, the DC/AC inverter 105, where size of active power is Pa′, and size of reactive power is Pr′. As a result, power corresponding to the power Pw′ demanded by the entire consuming loads may be compensated by the power converting device and supplied to a power system and power factor is balanced. Therefore, the power system may be prevented from becoming unstable. The power factor is maintained same before and after the compensation (cos θ=Pa/Pw=(Pa+Pa′)/Pw′).

A case in which only reactive power is compensated as shown in FIG. 9A is shown in (d) of FIG. 9B. Currently, in the power system, a consuming load demands Pw″. Although power factor of a grid is cos θ=Pa/Pw, the power factor of the consuming load needs to be cos θ′=Pa/Pw″.

Therefore, the power system may be stabilized by receiving information regarding the power factor demanded by the consuming load via the EMS 160 and generating only reactive power Pr″ in a power converter.

FIG. 9C is a block diagram of a current controller for controlling reactive power according to an embodiment of the present invention.

Referring to FIG. 9C, the current controller is converted single-phase currents into dq coordinates.

In FIG. 9C, an iq 913 denotes a q-axis current of an inverter-output current, whereas an id 923 denotes a d-axis current of the inverter-output current. Generally, a three-phase current may be converted to such a d-q current via d-q conversion. The iq is usually referred to as a torque current, whereas the id is usually referred to as a flux current.

An Eq 950 denotes a q-axis voltage that is input by a power system and is d-q converted, whereas an Ed 960 is a d-axis voltage that is input by the power system and is d-q converted. An iq* 910 denotes a q-axis reference current regarding size of a phase angle w, whereas an id* 920 denotes a d-axis reference current regarding size of the phase angle w. A wL 970 denotes a gain value of the current controller, where w denotes a phase difference between an output current and an output voltage. Generally, θ/t=w=2πf.

At a current controller 900, which is the front-end, differences between the reference currents iq* 910 and id* 920 and actual currents iq 911 and id 921 become inputs of PI controllers 930 and 940, and current control is performed by adding and subtracting values wL* iq* and wL* id* to and from outputs of the PI controllers 930 and 940. At a rear-end system 990, currents iq 913 and id 923 supplied to a power system are generated from output voltages of the current controller. The current controller 900 enables power control in consideration of reactive power of the present application and may control voltages and phases. The current control may be performed by the EMS 160 of FIG. 4A, for example.

FIG. 10 is a diagram showing a system for controlling reactive power and an example of operations for converting powers from a renewable energy source and a battery, according to an embodiment of the present invention.

As in FIG. 9A, power factors of the consuming loads 180 and 190 are low and it is necessary to control reactive power, the EMS 160 may receive information regarding the power factors demanded by the consuming loads 180 and 190 and stabilize a power system by controlling reactive power by using the multi-functional power conversion system 100. The method of stabilization is as described above with reference to FIG. 9B.

FIG. 11 is a diagram showing an example of operations for converting powers from a renewable energy and a battery when a grid is blocked, according to an embodiment of the present invention.

If the grid 140 is blocked but the consuming loads 180 and 190 still demand power, the EMS 160 receives a communication indicating the power blockage and supplies power to the consuming loads 180 and 190 via wind power generator 110, the solar power generator 130, or, if possible, the battery bank 150 by immediately controlling the multi-functional power conversion system 100. For example, if power supplied from Korea Electric Power Corporation is blocked by an accident, the multi-functional power conversion system 100 may temporarily function as a large-scale uninterruptible power supply (UPS) for preventing power interruption by using the alternative energy supply sources.

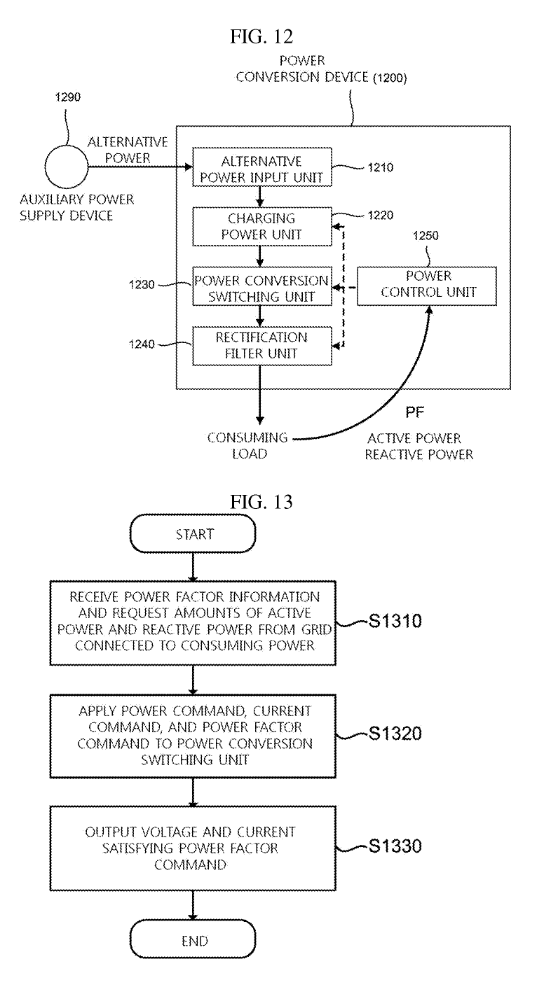

FIG. 12 is a block diagram of a power conversion device 1200 capable of controlling reactive power according to an embodiment of the present invention.

In FIG. 12, an alternative power input unit 1210 of the power conversion device 1200 receives alternative power from an auxiliary power supply device 1290, which is any of various alternative energy sources stated above. If the supplied alternative energy is generated as AC power, the supplied alternative energy is converted to DC power via AC/DC switching in advance. If the supplied alternative energy is generated as DC power, the supplied alternative energy may be stored in a charging power supply unit 1220, such as a battery bank, directly or via a simple filter. The charging power supply unit 1220 includes a capacitance component for performing a charging operation. If charging is not required, the charging power supply unit 1220 may be directly connected to a consuming load via a power conversion switching unit 1230. The power conversion switching unit 1230 may convert DC power to AC power via a switching operation, e.g., PWM, and supply the AC power to the consuming load or a grid. As known in the art, when power generated by an alternative energy source or power generated by a consumer is supplied to a power infrastructure (grid) such as Korea Electric Power Corporation, profits may be made therefrom.

AC power generated by the power conversion switching unit 1230 is filtered by a rectification filter unit 1240 including an inductor. A power control unit 1250 receives feedbacks of a power factor, demanded active power, and demanded reactive power from a consuming load connected to the output end of the power conversion device 1200 and control a phase difference between a voltage and a current output by the power conversion switching unit 1230, thereby supplying active power and reactive power demanded by the consuming load to a power system according to the power factor. As described above, the power conversion device 1200 of the present application not only simply supplies active power to a power system, but also receives a feedback of a power factor of a consuming load and controls power conversion switching, such that active power and reactive power satisfies demands of the consuming load.

If it is not necessary to supply power from the auxiliary power supply device 1290 or the charging power supply unit 1220 to the consuming load, the power control unit 1250 charges power from the auxiliary power supply device 1290 to the charging power supply unit 1220. Furthermore, the power control unit 1250 may charge electric power to the charging power supply unit 1220 via the power conversion switching unit 1230 from a power infrastructure of an organization such as Korea Electric Power Corporation, which supplies power to the consuming load.

Furthermore, the power control unit 1250 may supply alternative energy input via the charging power supply unit 1220 or the alternative power input unit 1210 to a power infrastructure via the power conversion switching unit 1230.

FIG. 13 is a flowchart showing a method by which a power controller of a power converter receives information regarding a power factor, demanded active power, and demanded reactive power from a grid to which a consuming load is connected and supplies a voltage and a current to stabilize a power system.

First, the power controller of the power converter receives feedbacks of a power factor, demanded active power, and demanded reactive power from the grid to which the consuming load is connected (operation S1310).

The power controller applies a voltage command, a current command, and a power factor command for applying a phase difference between a voltage and a current to be generated to a power conversion switching unit, based on the power factor, the demanded active power, and the demanded reactive power (operation S1320). The voltage command indicates size of a voltage to be generated, the current command indicates size of a current to be generated, and the power factor command is a command for controlling a phase difference between the voltage and the current by controlling power conversion switching. If the power converter only supplies reactive power, the phase difference between the voltage and the current will be 90 degrees according to the power factor command.

The power conversion switching unit supplies the voltage and the current to the consuming load from at least one power supply device from among one or more auxiliary power supply devices and charging power supply devices, based on the voltage command, the current command, and the power factor command (operation S1330).

The phase difference between the generated voltage and the generated current is controlled to maintain power factor according to the information provided by the grid or the consuming load. If no active power and no reactive power are demanded, the power controller charges power from at least one power supply device from between the grid and the auxiliary power supply device to the charging power supply unit.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

According to the embodiments of the present invention, power supply in a power system may be maintained stable by utilizing alternative power supply sources, such as various renewable energy sources.

In addition, according to the embodiments of the poser invention, power of a power system may be efficiently utilized by receiving information regarding active powers and reactive powers at a power supplying grid and a consumer load and compensating not only the active power, but also the reactive power. Therefore, fossil energy used for power generation may be reduced.

1. A power conversion device capable of controlling reactive power, the power conversion device comprising:
an alternative power input unit receiving alternative power from one or more auxiliary power supply device;
a power conversion switching unit converting power received via the alternative power input unit to AC power;
a charging power supply unit connected to the alternative power input unit and stores power supplied from at least one from between the alternative power input unit and a grid; and
a power control unit, which receives information regarding a power factor, demanded active power, and demanded reactive power from the grid connected to a consuming load and controls a voltage and a current output by the power conversion switching unit and a phase difference between the voltage and the current to satisfy the power factor, the demanded active power, and the demanded reactive power received from the grid.

2. The power conversion device of claim 1, wherein the power control unit charges power received via the alternative power input unit from the auxiliary power supply device to the charging power supply unit, if it is not necessary to supply power from the alternative power input unit or the charging power supply unit to the consuming load.

3. The power conversion device of claim 1, wherein the power control unit charges power from the grid to the charging power supply unit, if it is not necessary to supply power from the grid to the consuming load or there is surplus power.

4. A power conversion method capable of controlling reactive power, the power conversion method comprising:
an operation in which a power control unit receives information regarding a power factor, demanded active power, and demanded reactive power from a grid connected to a consuming load;
an operation in which the power control unit applies a voltage command, a current command, and a power factor command for applying a phase difference between a voltage and a current to be generated to a power conversion switching unit, based on the power factor, the demanded active power, and the demanded reactive power; and
an operation in which the power conversion switching unit supplies a voltage and a current from at least one power supply device from among one or more auxiliary power supply devices and charging power supply devices, based on the voltage command, the current command, and the power factor command.

5. The power conversion method of claim 4, wherein the phase difference between the generated voltage and the generated current is controlled to maintain power factor according to the information provided by the grid.

6. The power conversion method of claim 4, further comprising an operation in which, if no active power and no reactive power are demanded, the power controller charges power from at least one power supply device from between the grid and the auxiliary power supply device to the charging power supply unit.
